(19) United States
(12) Patent Application Publication
(10) Pub. No.: US 2006/0232020 A1
(43) Pub. Date: Oct. 19, 2006

(54) Collet liner

(76) Inventor: Edward B. Miller, Naples, FL (US)

Correspondence Address: KEITH J JEFFRIES, P O BOX 505, BUCHINGHAM, PA, 18912, US

(21) Appl. No.: 11/104,926

(22) Filed: Apr. 13, 2005

(51) Int. Cl. B23B 31/12

(52) U.S. Cl. 279/43.1

(57) ABSTRACT

The present collet liner is fabricated from a precision rod of less hard material than the hard material of a collet to interpose and coact radially within the collet barrel. The liner has an inwardly directed common rod portion which is externally threaded at its rear end while the front end has three symmetrical triangular finger sections separated by longitudinal slots which extend inwardly through the finger sections into grooves of three symmetrically disposed sections of a web portion. The externally threaded section is releasably mountable within the internally threaded barrel of the collet having an internally threaded collar. The length of the liner is fixedly secured by fastening flats machined on the externally threaded section abutting the cylindrical base.

### BACKGROUND OF THE INVENTION

The invention relates to a collet liner having precision surfaces which retro-fit into the through bore surfaces of most standard collets and, more particularly, it concerns accurately boring the less hard material of the collet liner having three 120° finger separations bringing excellent concentricity to its workpiece holding surfaces.

Rotating machine tools, such as lathes, are well known in the manufacturing industry. Lathes have a fundamental operation of securing the workpiece while it is being shaped, formed, drilled, chamfered, or otherwise worked on. The workpiece must be secured tightly and positioned accurately in order to accomplish all operations within acceptable tolerances. The lathes have a horizontal rotatingly powered spindle for shaping a workpiece mounted in a locking device and rotating it against a cutting tool for turning, boring, facing or threading generally cylindrical objects.

Collets are well known locking devices used with lathes' spindles for holding the workpiece rigid by means of an actuator. Collets comprise split, coned or tapered sleeves for holding generally circular workpieces being worked. Collets are selectively adjustable to bring tapered surfaces or contractable springlike jaws to clamp around the workpiece. Various size collets including 3J, 3C, 3AT, 5-C, No.7B & S-tapered, 16C, as well as other common types of collets.

The common set of collets known as “5-C” collets are most commonly designed for use with lathes. All “5-C” collets have the same external dimensions and are acceptable in the same collet locking devices, spindles and collet actuators. Typically, collets include a cylindrical shank with threaded end of fixed dimensions and the front end is varied according to workpiece size and function. A common problem with using collets, in general, is runout or poor spindle tolerance which occurs from mishaps, heavy use or poor maintenance over time thus causing failure of the lathe's spindle in spinning concentrically while holding the workpiece thereby failing to produce an accurate workpiece product.

### SUMMARY OF THE INVENTION

In accordance with the present invention, a unique collet liner is provided to operate in unison with almost all industry standard collets including 5C style, 16C style, 3C style, as well as other common collets. The present collet liner is an improvement over prior devices by providing more precise spindle tolerance for workpieces worked on tool lathes or by collet actuator. It's use prevents undesirable runout from occurring which occurs when the lathe's spindle fails to spin concentrically while holding the workpiece thereby resulting in poor spindle tolerances. An exact use of the collet liner would be performing second operations on a workpiece that has been previously machined. The collet liner will now allow excellent concentric gripping of the workpiece regardless of the lathe machine age, accuracy or spindle quality. Present tolerances have proven to be within 0.0005 inch to 50 millionths inch diameter deviation on workpieces of secondary machining operations involving collet liner applications.

The collet liner of the invention is fabricated from a precision rod constructed to be interposed within the entire length in the axial direction of the barrel of a collet. The liner provides an inwardly directed common rod portion which is externally screw threaded at its slotted rear end to be received and mated within the internally threaded cylindrical base portion enclosure of the collet. The front end fingers'portion of the liner is divided into three symmetrically disposed outwardly flared flat triangular finger sections having outer circumference surfaces which are arcually rounded. The individual finger sections are separated by slots and grooves interposed parallel to the axis. The slots extend inwardly into a web portion of reduced diameter divided into three symmetrically disposed arcually rounded sections of the liner separated by grooves. The end of the web portion abuts the shoulder of the front smooth surface of increased diameter of the common rod portion of the liner.

The present liner retrofits into most standard collets, in particular, collets of the “5C” series and other common types. In operation, the liner fits into the barrel of the collet with the liner's externally screw threaded rear slotted end of the common rod engaged in the internally threaded cylindrical collet rear base. It is threadedly secured in the collet which is threadedly engaged in a collet actuator, whereby the slots and grooves between the fingers portion and web portion of the liner are reduced in size by means of tightening the grip by means of collet actuator. A bore hole machined in the tightened fingers and web portions of the less hard material of the liner provides excellent concentricity to the liner's work holding surfaces. This is achieved by machining a work holding surface by the same machine lathe which performs the machine operation, by rectifying the runout error to achieve excellent concentricity.

### BRIEF DESCRIPTION OF THE DRAWINGS

FIG. 1 is a side section view of a common “5C” collet.

FIG. 2 is a side section view of the collet liner of the invention.

FIG. 3 is a front end view of the collet of FIG. 1 showing the front end view of the collet liner secured within the collet.

FIG. 4 is a side section view of the collet liner secured with the collet.

FIG. 5 depicts generally a section side view of the collet liner in assembled relationship with collet and the liner enclosing a work tool.

### DETAILED DESCRIPTION OF THE PREFERRED EMBODIMENT

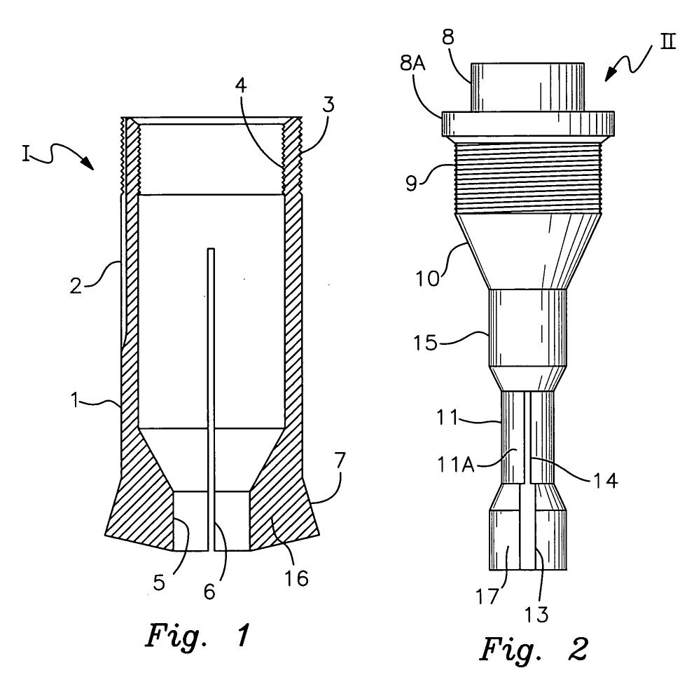

Shown in FIGS. 1, 2, 3, 4 and 5 are views of the collet liner of the present invention in position with a “5C” series type collet. The “5C” collet I is one of the standard types of collets within which the present liner is to be interposed. Collet liner II is fabricated from a precision rod which is made from materials, less hardened than the hard material of the “5C” collet, preferably metals such as tool steels, brass, aluminum, titanium, or from plastics and other ferrous and nonferrous materials.

Shown in FIG. 1 is a side section view of a common “5C” collet depicting the collet body 1, orientation groove 2 which allows coacting with a machine spindle, external threads 3 which allow engaging the spindle thread for secure fit, internal threads 4 which interface engage collet liner II to the body of collet I, common bored through surface 5 of the collet's, 120 degrees machined separations to allow common “5C” collet flexure, and common “SC” collet taper surface 7 which allows actuating with the machine lathe like spindle taper.

Shown in FIG. 2 is a side section view of collet liner II of the invention depicting back end fastening flats 8 which is firmly inserted, positioned and secured within collet I by means of an open end wrench, not shown. The liner's external threads 9 releasably engage the collets internal threads 4. Tapered main body 10 of the liner extends downwardly merging with increased diameter common rod section 15 congrual to reduced diameter web portion 11 which coacts with front segmented fingers portion 12.

The front segmented fingers section of the liner is divided into three symmetrically disposed, outwardly flared, flat triangular finger sections 17, each one hundred and twenty degrees, having outer surfaces that are arcually rounded. The individual finger sections 17 are separated by slots 13 interposed parallel to the axis. Slots 13 extend inwardly through the finger sections into grooves 14 which pass through a large area of a reduced diameter web portion 11 partially divided into three symmetrically disposed, arcually rounded sections 11A of the web portion. The web portion 11 being integral with the front solid section 15 of the increased diameter common rod portion of the liner.

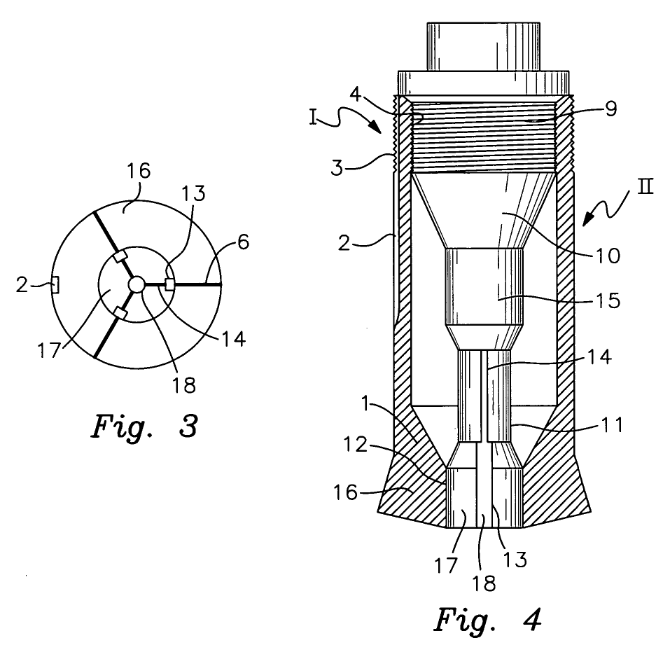

Shown in FIG. 3 is a section front end view of collet I depicting collet liner II interposed within body 1 of the collet. As depicted, collet I 120° segmented face sections 16 abut collet liner II 120° segmented face sections 17. Bore hole 18, depicted bored within the liner's segmented fingers sections 17 supports a workpiece by pressure exerted therein. The precision exterior surfaces 12 of the liner's segmented finger section 17 interposed within the collet's segmented sections 16 simultaneously actuate with collet's I through bore surfaces 5 which minimizes the closing function implementing in the machine lathe operation. Collet liner II slots 13 with adjoining grooves 14 being positioned adjacent to collet I grooves 6 provide for improved manufacturing technique. Collett liner II slots 13 and grooves 14 are machined proportionally according to the size of the workpiece. Slots 13 generally will be larger to hold a workpiece having increased diameter and the web portion 11 and grooves 14 will be larger in direct relationship with the size of the slots.

Depicted in FIG. 4 is a section view of liner II interposed within body 1 of collet I. The liner's fastening flats 8 in the rear end of the device releasably engage the liner's external threads 9 within the collet's internal threads 4. Within body 1 of the collet, the liner's elements tapered main body 10 extends downwardly to common rod section 15 which merges with web portion 11 to coact front fingers portion 17 within segmented sections 16 of the collet.

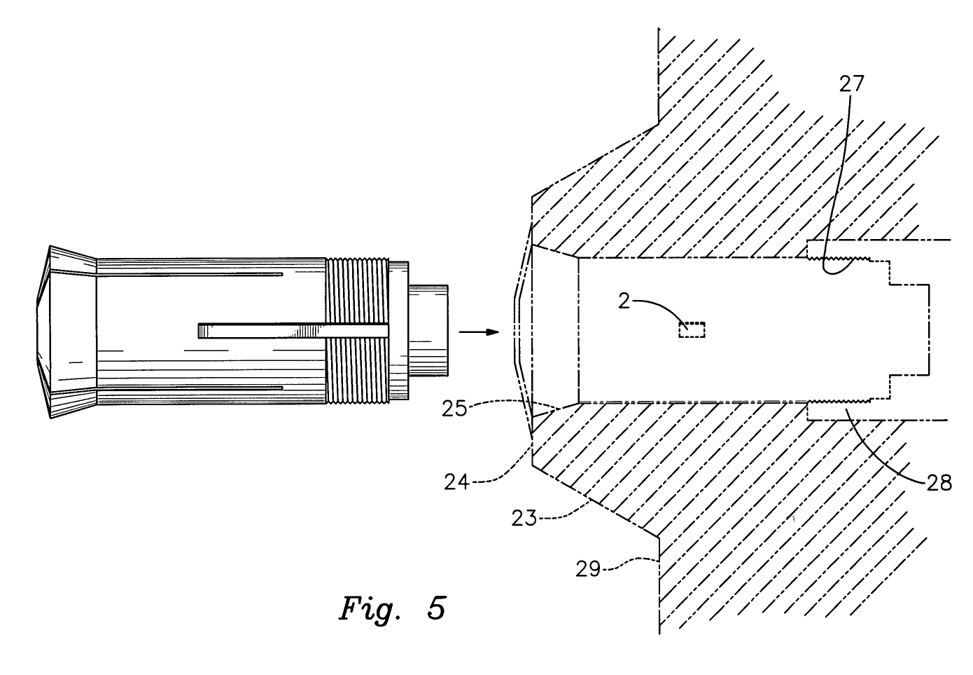

FIG. 5 generally depicts a vague illustration of the outer housing 23 of a spindle machine lathe indicating the spindle housing face 24, the machine spindle taper 25 wherein the surface is held stationary on the lathe by lock down draw bar 28. Collet I taper surfaces 7 actuate from spindle taper surface 25, thereby collet internal bore surface 5 actuates with collet liner exterior precision finger segmented section 17 surface implementing secure holding of the workpiece. The orientation key coacts with orientation groove 2 of the collet. The machine lathe threads 27 threadedly engage collet's external threads 3 prior to the draw bar lock down. The end 28 of the actuator which threads 27 are an integral detail, actuated by sliding using manual or automated means front spindle machine chasis 29.

Collet liner II fits into collet I as depicted in FIGS. 3 and 4. The liner having slotted end wall section 8 machined within cylindrical base 8A is constructed to be interposed within the body 1 of the collet. The liner retro-fits into the collet body 1 by adjacently aligning its body 1 by mating the externally screw threaded collar 9 of the cylindrical base 8A within the internally threaded rear end 4 of the collet by tightening fastening flats 8. The collet is threadedly engaged in collet actuator whereby the slots 13 between the segmented fingers 17 and grooves 14 of web portion 11 of the liner are reduced in size by tightening the grip on the collet's segmented sections 16. A bore hole 18 is bored by means of a boring tool in the less hardened material of the liner generally down to about the desired holding depth of the web portion 11. The collet segmented section are then opened and the workpiece is inserted into the bore hole 18 of the liner which is secured in the collet and is ready to operate.

The concept of collet's principle is transferred to the collet liner by reacting together in unity when being used. It allows the liner to function harmoniously in holding a workpiece. Accuracy is achieved in truing the liner by boring the less hard liner material, thus bringing excellent concentricity to the liner's work holding surfaces. The collet liner is of unibody design encompassing a quick practical solution for machining accurately which avoids the high cost of machine refurbishment.

It will be appreciated that as a result of the present invention, a highly effective collet liner is provided for standard collets of the type described. It is to be understood, however, that while the invention has been disclosed in relation to 5C series collets, the liner is adapted to other collets. Other modifications and/or changes may be made in the disclosed embodiment without departure from the present invention. Accordingly, it is to be expressly understood that the foregoing description and drawings are representative of a preferred embodiment only, not limiting, and that the true spirit and scope of the present invention is to be determined by reference to the appended claims.

What is claimed is:

1. A collet liner providing precise tolerance for a secured workpiece worked on a tool lathe comprising;
a solid rod structured to interpose and coact radially within a standard collet cylindrical barrel of a standard collet hard material,
said rod, providing less hard material than said standard collet hard material, and having a front portion divided into three symmetrical finger sections separated by longitudinal slots and grooves extending inwardly into the solid rod which is positioned on a cylindrical base releasably mountable within the collet barrel,
said finger sections having a central predetermined sized bore for securing the workpiece.

2. The collet liner according to claim 1 wherein each finger section has a triangular structure radially positioned.

3. The collet liner according to claim 1 wherein the finger sections have flat front surfaces and rounded exterior surfaces complementing the collet.

4. The collet liner according to claim 2 wherein the longitudinal slots extend inwardly into a smaller diameter web portion grooves congrual to a larger diameter rod portion.

5. The collet liner according to claim 4 wherein the larger diameter rod portion terminates into an externally tapered rod portion.

6. The collet liner according to claim 5 wherein the externally tapered rod portion abuts an externally threaded section on the cylindrical base.

7. The collet liner according to claim 6 wherein the externally threaded section is releasably engagable within the collet barrel.

8. The collet liner according to claim 7 wherein terminal fastening flats are provided in the terminally mountable and securing rod which control positioning and securing of the rod in the collet barrel.

9. The collet liner according to claim 1 wherein said bore is sized in the rod when clamped within the collet barrel.

10. The collet liner according to claim 9 wherein the bore is sized when the fingers are clamped into closed positions by a collet actuator.

11. The collet liner according to claim 1 wherein the standard collet hard material is metal.

12. The collet liner according to claim 1 wherein the standard collet hard material is plastic.

13. The collet liner of claim 1 wherein the less hard material is metal.

14. The collet liner of claim 1 wherein the less hard material is plastic.

15. The collet liner according to claim 1 interposed within a standard collet.
